(19) United States
(12) Patent Application Publication
(10) Pub. No.: US 2016/0292754 A1
(43) Pub. Date: Oct. 6, 2016

(54) METHOD OF SENDING AND TRACKING DONATIONS

(71) Applicant: Pif Life, L.L.C., Raleigh, NC (US)

(72) Inventors: Jeffrey David LYNCH, Raleigh, NC (US); Marty Lynn Lynch, Raleigh, NC (US)

(21) Appl. No.: 14/672,723

(22) Filed: Mar. 30, 2015

(51) Int. Cl. G06Q 30/02; G06Q 20/34

(52) U.S. Cl. CPC G06Q 30/0279; G06Q 20/34

(57) ABSTRACT

A method of making and tracking donations is provided. The present invention may include a platform displayed from a website on a computer or application on a smart device. A user may use the platform to purchase a card. The card is assigned a unique code, which may be printed on the surface of the card. The card is then sent to the user and the user enters the unique code in the platform. The user makes a donation to an entity and then enters information including details about the donation. The information is linked with the unique code and is stored on a database. The user transfers the card to a second user. The second user may enter the unique code on the platform and the details of the donation are displayed. The second user may then be prompted to make another donation and send the card to a third user.

### BACKGROUND OF THE INVENTION

The present invention relates to donations and, more particularly, to a method of sending and tracking donations.

Currently there is no trackable system and physical medium that enables a person to pass along a gift or message as an act of kindness. Further, charities, organizations or individuals do not have the ability to track funds raised, funds paid forward, a number of people in a gift chain, and view stories from future donators.

As can be seen, there is a need for a method of sending and tracking gifts.

### SUMMARY OF THE INVENTION

In one aspect of the present invention, a method of sending and tracking gifts to at least a second user comprises the steps of: prompting a user to purchase a card comprising a unique code via software executing on a computer; sending a hard copy of the card to the user; prompting the user to enter the unique code via software executing on a computer; prompting the user to enter information comprising details about a gift via software executing on a computer; linking an entered information comprising details about the gift with the unique code via software executing on a computer; storing a linked entered information and unique code in a database via software executing on a computer; and sending the gift and the card to the second user.

These and other features, aspects and advantages of the present invention will become better understood with reference to the following drawings, description and claims.

### BRIEF DESCRIPTION OF THE DRAWINGS

FIG. 1 is a front elevation view of a pouch of an embodiment of the present invention;

FIG. 2 is a rear elevation view of the pouch of FIG. 1;

FIG. 3 is a flowchart of an exemplary embodiment of the present invention; and

FIG. 4 is a screen shot displayed on a computing device of an exemplary platform of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The present invention may include a pouch and card containing a unique code used to track pay it forward activities via a designated platform website or application. An individual or organization, through the use of a uniquely coded card with a pouch, can track the individual pay it forward acts throughout the life of the pouch on the website, mobile application and social media platform which provides detailed analytics for each pass of the pouch that tracks charitable funds, monetary values, personal experiences, and geographic monitoring. The pay it forward concept is improved by introducing a physical and trackable medium (pouch and card) with the ability to track analytics while having a higher level of engagement. Further, the present invention allows charities, organizations or individuals to have a greater reach beyond just the initial person's charitable donation resulting in more funds raised and more community awareness.

The present invention includes a method of making and tracking donations provided by a plurality of users. The donations may be made to any entity, including a charity, a startup company in need of crowd funding, an individual in need of help and the like. The present invention may include a platform displayed from a website on a computer or application on a smart device. A user may use the platform to purchase a card. The card is assigned a unique code, which may be printed on the surface of the card. The card is then sent to the user and the user enters the unique code in the platform. The user then makes a donation to an entity and enters information including details about the donation. The information about the donation may include the amount of money donated, the reasons for the donation, details about the entity donated to and the like. The information is linked with the unique code and is stored on a database. The user then sends the card to the second user. In certain embodiments, the user may also send a gift to the second user.

Once the gift and card has been received by the second user, the second user may enter the unique code on the platform. When the unique code is entered, the information including the details of the donation is displayed to the second user. The second user may be prompted to make another donation. The second user may then decide to continue the chain and donate to the particular entity the first user donated to or the second user may donate to a different entity. In such embodiments, the second user enters information including details about a second donation. The information about the second donation is linked to the unique code and saved on the database. The second user may further purchase a second gift and send the second gift and card to a third user.

The third user may then perform the same steps as the second user. For example, the third user may enter the unique code on the platform. When the unique code is entered, the information including the details of the first donation, and the second donation are displayed to the third user. The third user may then decide to continue the chain and donate to the entity the first or second user donated to or the third user may donate to a different entity. In such embodiments, the third user enters information including details about a third donation. The information about the third donation is linked to the unique code and saved on the database. The third user may purchase a third gift and send the third gift and card to a fourth user and so on. Any of the users described above that are within the chain may enter the unique code on the platform at any time to view and track future donations sent out by future users.

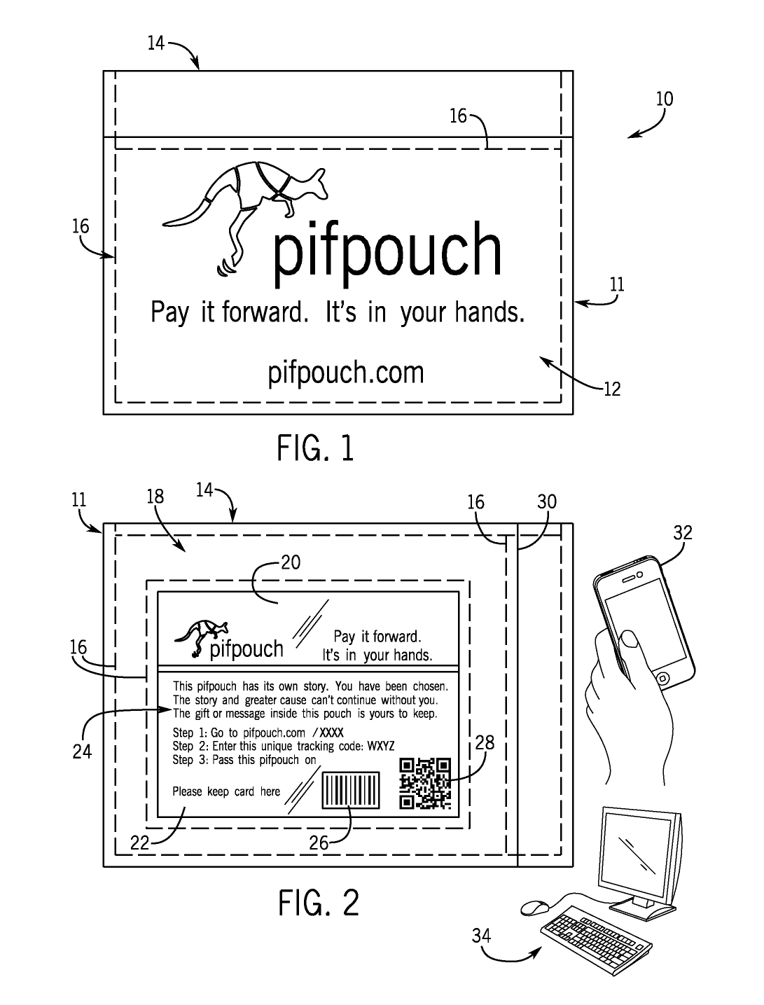

Referring to FIGS. 1 and 2, the present invention includes a tracking mechanism 10. The tracking mechanism 10 includes the card 22. The card 22 may be made of a hard plastic and may include a size similar to a credit or Identification card. In certain embodiments, the card 22 may be removeably secured within a card holder 11. The card holder 11 may include a top opening 14 leading into the card holder 11 to place the gift within. The card holder 11 may further includes a card insertion slot 30 to insert and remove the card 22. The top opening 14 and the card insertion slot 30 may be closable by zippers, snaps, clasps and the like. The card holder 11 may include a weather resistant pouch having a seam 16 forming a first compartment 18 for the gift and a second compartment for the card 22. The card holder 11 may further include a transparent window 20 to view the card 22 within.

The card 22 of the present invention may include the unique code printed on the surface. In certain embodiments, the unique code may be in the form of a barcode 26 and a QR code 28. The card 22 may further include instructions 24 on how to use the present invention, as well as logos for company branding and sponsorships. The instructions 24 may include the website that may be entered into the computer 34, the unique code to be entered into the computer 34 when accessing the website, and instructions to further pass the present invention to a future user. In certain embodiments, when scanning a code via the barcode 26 or QR code 28, a scanner on a smart device 32 may be used. Once the smart device 32 has scanned the code, either the application on the phone or the website may automatically populate and display the page including the information on the past gifts.

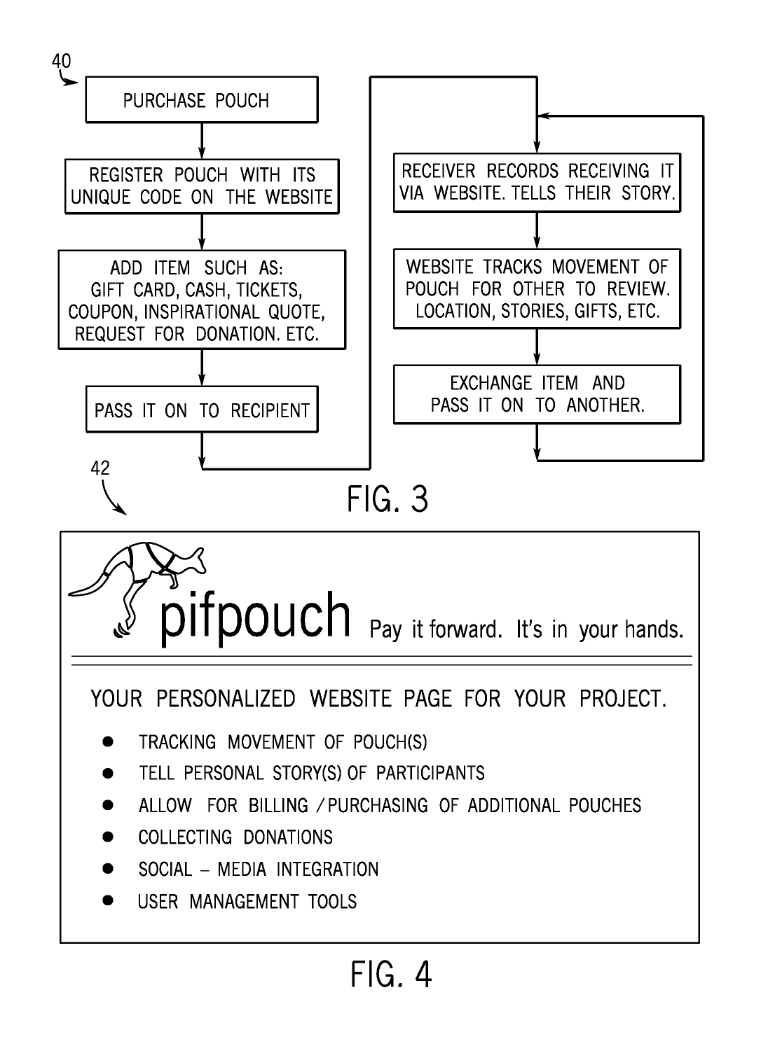

FIGS. 3 and 4, illustrate a flowchart method 40 and screen shot 42 of an exemplary platform displayed on a computer. The method may include purchasing the pouch, registering the pouch with its unique code on the website, adding items, such as gift cards, cash, tickets, coupons, inspirational quotes, requests for donations, and the like. The card and gift is then passed on to the recipient. The recipient (second user) records receiving it via the website and enters additional information. The website tracks the movement of the pouch for others to review, including locations, stories, gifts, and the like. The gifts or items are exchanged and passed on to another.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of making and tracking donations comprising the steps of:
(a) prompting a user to purchase a card comprising a unique code via software executing on a computer;
(b) sending a hard copy of the card to the user;
(c) prompting the user to enter the unique code via software executing on a computer;
(d) making a donation to an entity;
(e) prompting the user to enter information comprising details about the donation via software executing on a computer;
(f) linking an entered information comprising details about the donation with the unique code via software executing on a computer;
(g) storing a linked entered information and unique code in a database via software executing on a computer; and
(h) transferring the card to a second user.

2. The method of claim 1, further comprising the steps of:
(i) prompting the second user to enter the unique code via software executing on a computer; and
(j) displaying the information comprising details about the donation via software executing on a computer.

3. The method of claim 2, further comprising the steps of:
(k) prompting the second user to making a second donation to the entity via software executing on a computer;
(l) prompting the user to enter information comprising details about the second donation via software executing on a computer;
(m) linking an entered information comprising details about the second donation with the unique code via software executing on a computer;
(n) storing a linked entered information and unique code in a database via software executing on a computer; and
(o) transferring the card to a third user.

4. The method of claim 3, further comprising the steps of:
(p) prompting the third user to enter the unique code via software executing on a computer; and
(q) displaying the information comprising details about the donation and the second donation via software executing on a computer.

5. The method of claim 1, wherein the unique code is printed on the card as at least one of a QR code and a bar code.

6. The method of claim 5, wherein step (c) comprises prompting the user to scan at least one of the QR code and the bar code.

7. The method of claim 1, wherein the card is removeably secured within a card holder.

8. The method of claim 7 wherein the card holder is a weather proof pouch comprising at least one transparent window for viewing the card within.

9. The method of claim 1, further comprising the step of purchasing a gift and transferring the gift to the second user.
